(19) United States
(12) Patent Application Publication
(10) Pub. No.: US 2006/0140557 A1
(43) Pub. Date: Jun. 29, 2006

(54) FIBER OPTIC CABLE WITH STRENGTH MEMBER FORMED FROM A SHEET

(76) Inventors: Donald R. Parris, Newton, NC (US); Warren W. McAlpine, Hickory, NC (US)

Correspondence Address: CORNING CABLE SYSTEMS LLC, P O BOX 489, HICKORY, NC, 28603, US

(21) Appl. No.: 09/822,523

(22) Filed: Mar. 30, 2001

(51) Int. Cl. G02B 6/44

(52) U.S. Cl. 385/113

(57) ABSTRACT

A fiber optic cable having at least one optical fiber component disposed within at least one formed area of a strength member. The strength member including a metallic or dielectric sheet having the formed area generally formed relative to an axis of the cable. The cable also includes a cable jacket substantially surrounding the strength member. The cable may include a decoupling zone adjacent the optical fiber component, a water-blocking component and/or an interfacial layer at least partially disposed between an outer surface of the strength member and the cable jacket. Another embodiment is a composite cable having a strength member formed from a sheet. The strength member further comprises an interior space having a central electrical conductor surround by a dielectric material at least partially filling the interior space and functioning as an insulator between the central electrical conductor and said strength member.

### FIELD OF THE INVENTION

The present invention relates generally to fiber optic cables and, more particularly, to fiber optic drop cables.

### BACKGROUND OF THE INVENTION

Fiber optic cables include optical fibers that are capable of transmitting voice, video, and data signals. Fiber optic cables have advantages over electrical voice, video and data signal carriers, for example, increased data capacity. As businesses and households demand increased data capacity, fiber optic cables can eventually displace electrical voice, video, and data signal carriers. This demand will require low fiber count optical cables to be routed to end users, for example, businesses and households.

Fiber optic cables can typically be used in various applications. For example, fiber optic drop cables may be suitable for both aerial and buried cable applications. More specifically, a fiber optic drop cable may be strung between poles and/or buried in the ground before reaching the end user. Aerial and buried cable environments have unique requirements and considerations. Optical fiber drop cables can meet the unique requirements and considerations of both environments, yet still remain cost effective.

In addition to being cost effective, cables should be simple to manufacture. An example of a low fiber count optical cable having an optical fiber orientated longitudinally and surrounded by an electrically conductive support member is disclosed in U.S. Pat. No. 5,115,485. The electrically conductive support member is surrounded and embedded in an elastomeric material that forms the outer jacket. The cable also includes optical fibers embedded in the elastomeric material that forms the outer jacket. This known fiber optic cable has several disadvantages. For example, because the optical fiber is surrounded by the electrically conductive support member, it is difficult to access the fiber. Moreover, accessing the central optical fiber may result in damage to the embedded optical fibers. Additionally, the embedded optical fibers are coupled to the elastomeric material that forms the outer jacket. Consequently, when the elastomeric outer jacket is stressed, for example, during bending or temperature cycling, tensile and compressive stresses can be transferred to the optical fibers, thereby degrading optical performance.

Moreover, fiber optic cables that are strung between poles can carry a tensile load. An example of a fiber optic cable designed to carry a tensile load is disclosed in U.S. Pat. No. 4,422,889. This known cable is an optical fiber cable with a generally cylindrical central strength member having helical grooves for carrying optical fibers. During manufacture, the grooves require partial filling with a viscous filling compound, placing the optical fiber in the partially filled groove, and then filling the partially filled groove with the optical fiber with further viscous filling compound. Although this known fiber optic cable is designed to prevent the application of tensile stress to the optical fibers by allowing the fibers to sink deeper into the grooves when axially loaded, this design has several disadvantages. For example, from a manufacturing standpoint, it can be more difficult and expensive to form helical grooves and to place the optical fibers in helical grooves.

### ASPECTS OF THE INVENTION

One aspect of the present invention provides a fiber optic cable having a strength member comprising a sheet manufactured in a forming process. The cable having at least one optical fiber component disposed within at least one formed area of the strength member. The at least one formed area having a fiber access opening being disposed generally relative to an axis of the cable. The cable includes a cable jacket generally surrounding the strength member. The cable may include a decoupling zone adjacent the optical fiber component, a water-blocking component, and/or an interfacial layer at least partially disposed between an outer surface of the strength member and the cable jacket. Additionally, this aspect can also be a composite cable having a strength member formed from a metallic sheet. The strength member further comprises an interior space having a central electrical conductor surrounded by a dielectric material at least partially filling the interior space and functioning as an insulator between the central electrical conductor and the strength member.

A second aspect of the present invention provides a fiber optic cable having a strength member comprising a sheet manufactured in a forming process. The cable having at least one optical fiber component disposed within at least one formed area of the strength member. The at least one formed area having a fiber access portion. The formed area being disposed generally relative to the longitudinal axis of the cable. The cable includes a decoupling zone adjacent the optical fiber component, at least one water-blocking component partially disposed in the formed area and an interfacial layer at least partially disposed between an outer surface of the strength member and a cable jacket generally surrounding the strength member. Additionally, this aspect can also be a composite cable having a strength member formed from a metallic sheet. The strength member further comprises an interior space having a central electrical conductor surrounded by a dielectric material at least partially filling the interior space and functioning as an insulator between the central electrical conductor and the strength member.

A third aspect of the present invention provides a fiber optic cable having a strength member comprising a sheet manufactured in a forming process. The cable having at least one optical fiber component disposed within at least one formed area of the strength member. The at least one formed area having a fiber access portion. The formed area disposed generally relative to an axis of the cable. The cable includes a cable jacket generally surrounding the strength member. The cable having a strain of 1.0% or less when a 1,000 lb. tensile force is applied. The cable may include a decoupling zone adjacent the optical fiber component, a water-blocking component, and/or an interfacial layer at least partially disposed between an outer surface of the strength member and the cable jacket. Additionally, this aspect can also be a composite cable having a strength member formed from a metallic sheet. The strength member further comprises an interior space having a central electrical conductor surrounded by a dielectric material at least partially filling the interior space and functioning as an insulator between the central electrical conductor and the strength member.

### BRIEF DESCRIPTION OF THE FIGURES

FIG. 1 is an isometric view of a fiber optic cable in accordance with an embodiment of the present invention.

FIG. 2 is a cross sectional view of the embodiment of FIG. 1 taken along line A-A.

FIG. 3 is a cross-sectional view of a fiber optic cable in accordance with another embodiment of the present invention.

FIG. 4 is a cross-sectional view of a fiber optic cable in accordance with an embodiment of the present invention.

FIG. 5 is a cross-sectional view of a fiber optic cable in accordance with an embodiment of the present invention.

FIG. 6 is a cross-sectional view of a fiber optic cable in accordance with an embodiment of the present invention.

FIG. 7 is a cross-sectional view of a fiber optic cable in accordance with an embodiment of the present invention.

FIG. 8a is a cross-sectional view of a blank in accordance with an embodiment of the present invention.

FIGS. 8b and 8e are views of the blank, as illustrated in FIG. 8a, after at least one forming step.

FIG. 8c is a cross-sectional view of the formed blank, as illustrated in FIG. 8a, after at least one forming step.

FIG. 8d is a cross-sectional view of a fiber optic cable, incorporating the formed blank, in accordance with an embodiment of the present invention.

FIG. 9 is a cross-sectional view of a composite cable in accordance with an embodiment of the present invention.

### DETAILED DESCRIPTION OF THE INVENTIONS

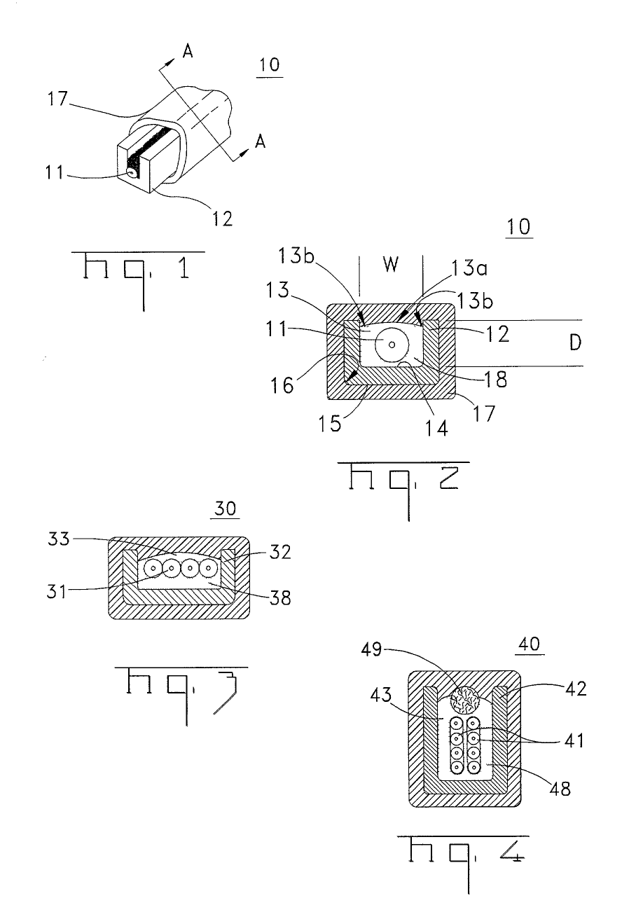

A fiber optic cable 10 according to an embodiment of the present invention is depicted in FIGS. 1 and 2. Fiber optic cable 10 includes a strength member 12 manufactured from a sheet-like material in a forming process. Cable 10 having at least one optical fiber component 11 disposed within a formed area 13 of strength member 12. Formed area 13 includes a fiber access portion 13a for accessing the fiber optic component 11. A cable jacket 17 substantially surrounds optical fiber component 11 and strength member 12. A decoupling zone 18 may be disposed adjacent to the optical fiber component, and a water-blocking component (FIG. 4) may be enclosed by the cable jacket 17.

Optical fiber component 11 preferably comprises at least one loose optical fiber. However, component 11 can be tight buffered, bundled or ribbonized optical fibers in a common matrix, a stack of optical fiber ribbons in a common matrix or any combination thereof. Each optical fiber preferably includes a silica-based core that is operative to transmit light and is surrounded by a silica-based cladding having a lower index of refraction than the core. A soft primary coating surrounds the cladding, and a relatively rigid secondary coating surrounds the primary coating. Each optical fiber can be, for example, a single-mode or multi-mode optical fiber available commercially from Corning Inc.

Decoupling zone 18 preferably preserves optical performance within desirable ranges. Decoupling zone 18 is preferably operable to space optical fiber component 11 from strength member 12. Preferably, decoupling zone 18 is generally interposed between strength member 12 and optical fiber component 11, and it advantageously spaces optical fiber component 11 from strength member 12. Most preferably, decoupling zone 18 substantially surrounds optical fiber component 11. The preferred decoupling zone 18 includes an optical filling compound, but may include materials such as aramid fibers, gels, foams, thermoplastic filling compounds, water-blocking compounds such as tapes, yarns and/or powders or any other suitable materials.

The preferred embodiment also includes an interfacial layer 15 at least partially disposed between an outer surface 16 of strength member 12 and cable jacket 17. Preferably, interfacial layer 15 includes a corrosion protection material, most preferably, ethylene acrylic acetate, which may require an adhesive for jacket removal. Interfacial layer 15 can include a water-swellable material, a material to promote adhesion between the strength member 12 and cable jacket 17, a primer, thermoplastic, tape, zinc, copper, other corrosion protective materials and/or a surface roughness for adhesion purposes.

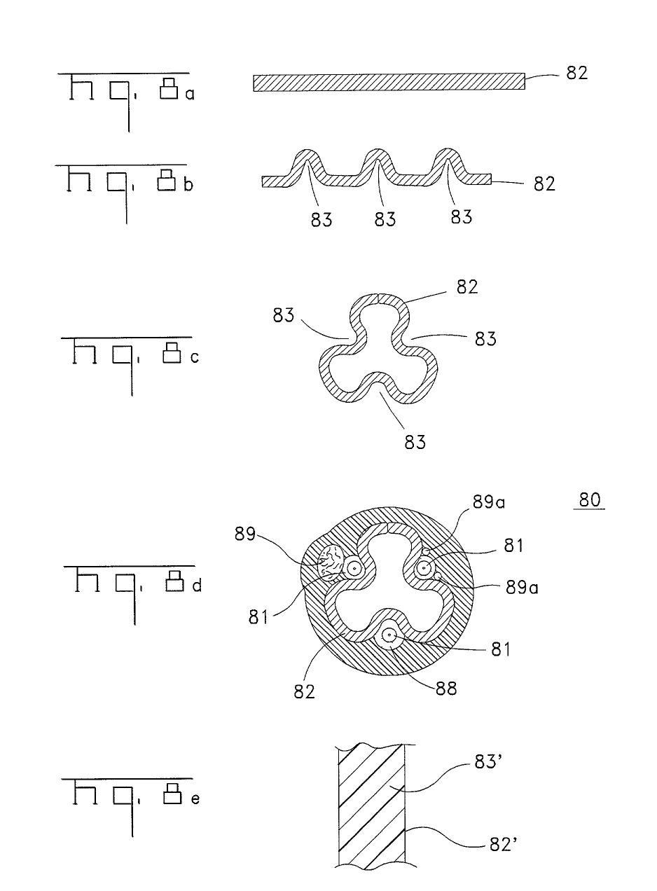

Cable 10 can include at least one water-blocking component, but preferably does not, disposed in formed area 13 of strength member 12. FIG. 4 illustrates water-blocking component 49, which generally includes water-swellable particles that swell upon exposure to water so as to form a blockage in the cable that inhibits the further migration of water in the cable. Generally, the water-swellable particles are formed of a superabsorbent polymer on a medium, for example, a yarn or tape, but can be in powder form. Preferred superabsorbent polymers are partially cross-linked polymers that absorb many times their own weight in water and swell considerably without dissolving, for example, acrylate, urethane or cellulosic-based superabsorbent materials. Water-blocking component 49 may also serve other functions; for example, the water-blocking component may also function as a ripcord for convenient fiber access. Component 49 can also function as indicia of fiber location by slightly protruding from the profile of the cable jacket (FIG. 8d).

Cable jacket 17 generally provides environmental protection and generally surrounds optical fiber component 11 and strength member 12. Cable jacket 17 can also be in communication with fiber access portion 13a. Cable jacket 17 is preferably formed of polyethylene or flame-retardant plastics, such as PVC or flame retardant polyethylene. A tube-on or pressure extrusion process can be used to apply cable jacket 17. The cable jacket generally has a thickness of about one millimeter and a shape that generally conforms to the shape of strength member 12, but cable jacket 17 can be used to fill areas and/or alter the cross-section of the cable. Furthermore, crush resistance can be incorporated by pressure extruding cable jacket 17 into interstices 13b of formed area 13.

Strength member 12 is most preferably a steel sheet of substantially uniform thickness that is shaped in a forming process. The sheet can also be a strip, tape, or foil, and can have a generally varying thickness. Preferred thickness of the steel sheet is generally about 0.25 millimeters to about 2 millimeters, most preferably about 0.50 millimeters to about 1.0 millimeters. Forming processes include, for example, bending, drawing, extruding, forming, rolling or any other suitable manufacturing process or technique. The preferred forming process is roll forming. Forming processes may include the application of heat depending on the material employed. Strength member 12 can be manufactured from any suitable dielectric or metallic material. Such materials include, for example, aluminum, copper, composite metals, plastics, or glass-reinforced plastics. In preferred embodiments, cables according to the present invention are mechanically robust, for example, strength member 12 preferably can withstand a predetermined tensile load, up to about 1000 lbs. or more. Additionally, cable 10 preferably has a minimum bend radius of about ten centimeters or less and a maximum span of preferably about two-hundred feet or more. Moreover, at the predetermined tensile load strength member 12 and/or cable 10 should have a strain in the range of essentially about 0% to about 1.0%, more preferably between essentially about 0% and about 0.3% and most preferably between essentially about 0% and about 0.1%. Additionally, the cable can have an excess fiber length to generally accommodate the range of strains. Excess fiber length in the cable 10 can be accomplished, for example, by placing the optical fiber component into a stressed strength member during the manufacturing process.

Formed area 13 comprises a fiber access portion 13a leading to an optical component receiving area. Fiber access portion 13a allows access to the optical fiber component 11 and generally can include a butted seam, lap joint or fiber access opening. Fiber access opening is generally an open side, or portion thereof, allowing access to the optical fiber component 11 without substantially disturbing strength member 12. Fiber access opening does not include a butted seam or lap joint. Formed area 13 can be various shapes, for example, arcuate, U, V, square, or any other suitable shape. In general, formed area 13 can be longitudinally or helically disposed with respect to the cable axis. Preferably, formed area 13 does not include sharp corners and/or edges, but may include a coating, for example, a thermoplastic layer, forming a smooth surface. The layer on formed area 13 can be the same or a different material that the material on the remaining outer surface of strength member 12. Moreover, an embodiment can include a formed area 13 having an air gap between the optical fiber component 11 and the formed area coating. The shape of formed area 13 can include a radius on corners and/or edges for avoiding stress concentrations in strength member 12. In the preferred embodiment, the corners and edges of formed area 13 have a radius of about zero to about 0.12 millimeters. Most preferably, the corners and edges of the formed area 13 have a radius of about 0.05 millimeters.

Formed area 13 can be sized to receive optical fiber component 11 and an optional water-blocking component 49 (FIG. 4). The geometry of strength member 12 can be selected to provide a preferential or non-preferential bend cable depending upon the application. FIG. 6 illustrates a non-preferential bend cable where the bending moment of inertia is roughly equal, or as close to equal as possible, between X and Y axes. However a slight or high preferential bend can also be advantageous. For example, FIG. 4 illustrates optical fiber component 41, more specifically, optical fiber ribbons having their preferential bend aligned with the preferential bend of the cable for reducing stress on component 41.

As illustrated in FIG. 2, a width ‘W’ of formed area 13 should be generally selected based upon the optical fiber component 11 that fiber optic cable 10 will employ, temperature range, preferential bend, stress and/or strain.

Formed area 13 also includes a depth ‘D’ as illustrated in FIG. 2. In an aspect of the present invention, depth ‘D’ of formed area 13 can be selected based upon optical fiber component 11 and water-blocking component 49, if any, that the fiber optic cable 10 may employ. In addition, depth ‘D’ is preferably selected based on such considerations as bending preference, crush ratings, strain and/or stress loads. In preferred embodiments, optical fiber component 11 will be located at about, or as close as possible, to a neutral bending axis of the cable that is generally perpendicular to ‘D’ for avoiding undue stress on the optical fiber component. In other words, in the preferred embodiment, optical fiber component 11 is located generally on a transverse plane, generally perpendicular to depth ‘D’, that preferably experiences about zero stress when the fiber optic cable is stressed in the ‘D’ direction. Most preferably, ‘D’ is predetermined with a dimension that positions optical fiber component 11 at, or as close as possible, to the neutral bending axis thereby allowing decoupling zone 18 space between a bottom surface 14 of formed area 13 and optical fiber component 11. Furthermore, as illustrated in FIG. 4, the strength member geometry can be taken into account for positioning the optical component at the neutral axis location. The strength member geometry may aid in locating optical fiber component 11 at or about the neutral axis.

Additionally, cable jacket 17 may include a formed area marking indicia (not illustrated) to aid in locating the optical fiber component 11. The preferred embodiment includes a cable jacket 17 marking indicia formed by a stripe, but may be a protrusion on the cable jacket 17, indentation, hot foil, dot, ink jet or laser printing or any other suitable indicia indicating the location of formed area 13. Indicia can also be an indentation as disclosed in U.S. Pat. No. 5,067,830, which is incorporated herein by reference.

Fiber optic cable 10 can have a range of outer diagonal, diameter or major transverse measurements, but preferably the outer diagonal, diameter or major transverse measurement is about one millimeters to about ten millimeters or more. Additionally, fiber optic cable 10 may have different shapes, for example, circular, rectangular, square or elliptical.

While fiber optic cable 10 depicted in FIGS. 1 and 2 is advantageous, for example, suitable for both aerial and buried cable environments, reliable and cost effective, fiber optic cable 10 may take other forms while still providing these same advantages. As shown in FIG. 3, for example, fiber optic cable 30 is another embodiment of the present invention. As described in conjunction with the embodiments of FIG. 1, fiber optic cable 30 includes an optical fiber component 31, comprising four loose optical fibers, adjacent a decoupling zone 38 in a formed area 33 of a strength member 32. Various shapes and depths can define formed area 33. The embodiment in FIG. 3 can include an interfacial layer on an outer surface of strength member 32, a decoupling zone, and/or a water-blocking component as described herein.

Illustrated in FIG. 4 is fiber optic cable 40 of another embodiment of the present invention. As described in conjunction with the embodiments of FIG. 1, fiber optic cable 40 includes a formed area 43 in a strength member 42. Formed area 43 is generally in the shape of a U, or optionally a V-shape, and can include various depths, widths and bottom curvatures such as flat or semi-circular. An optical fiber component 41 can be disposed within formed area 43. This embodiment includes two optical fiber ribbons adjacent a decoupling zone 48 and a water-blocking component 49 disposed in formed area 43. The embodiment in FIG. 4 can include an interfacial layer on an outer surface of strength member 42, a decoupling zone 48, and/or a water-blocking component as described herein.

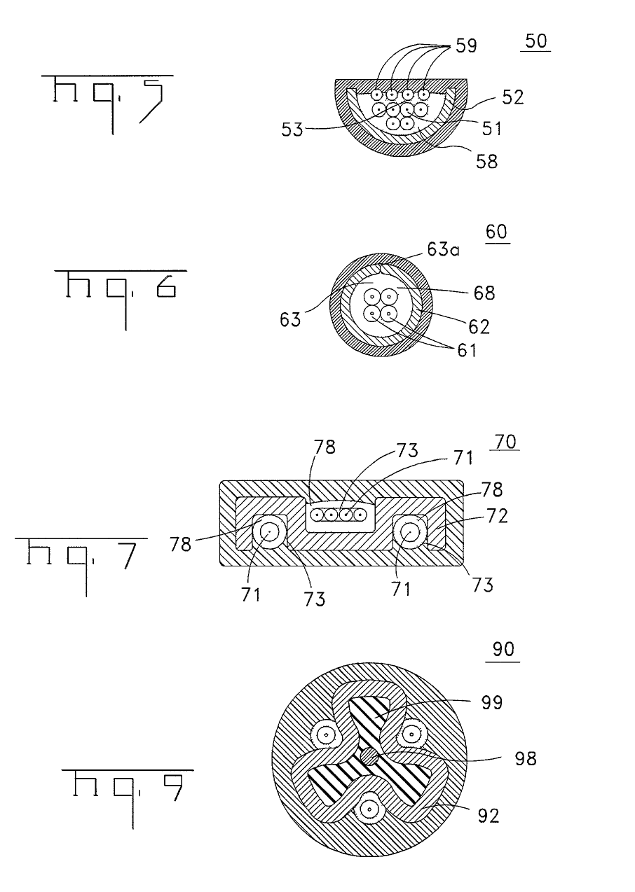

Illustrated in FIG. 5 is fiber optic cable 50 of another embodiment of the present invention. As described in conjunction with the embodiments of FIG. 1, fiber optic cable 50 includes a formed area 53 in a strength member 52. Formed area 53 is generally accurate, e.g., in the shape of a semi-circle. Various arc lengths and diameters can define formed area 53. Optical fiber component 51 can be disposed within formed area 53. This embodiment includes six loose optical fibers adjacent a decoupling zone 58 and a plurality of water-blocking components 59 in formed area 53. The embodiment in FIG. 5 can include an interfacial layer on an outer surface of strength member 52, a decoupling zone 58, and/or a water-blocking component 59 as described herein.

Illustrated in FIG. 6 is fiber optic cable 60 of another embodiment of the present invention. As described in conjunction with the embodiments of FIG. 1, fiber optic cable 60 includes a formed area 63 in a strength member 62. Formed area 63 is generally in the shape of an annular ring with the ends of the metal sheet being butted together to form fiber access portion 63a. Formed area 63 can include various diameters or various shapes formed by butting together ends of the metal sheet. Shapes include circular, elliptical, triangular, square, or D-shapes that substantially surround the optical fiber component. Alternatively, the fiber access portion 63a can include an overlap joint. Optical fiber component 61 can be disposed within formed area 63. This embodiment includes a plurality of loose optical fibers adjacent a decoupling zone 68. The embodiment in FIG. 6 may include an interfacial layer on an outer surface of strength member 62, a decoupling zone 68, and/or a water-blocking component as described herein.

Illustrated in FIG. 7 is fiber optic cable 70 of another embodiment of the present invention. As described in conjunction with the embodiments of FIG. 1, fiber optic cable 70 includes a plurality of formed areas 73 in a strength member 72. Formed areas 73 can be arranged in numerous configurations. Formed areas 73 are generally in the shape of a U, or optionally a V-shape, and can include various depths, widths and bottom curvatures such as flat or semi-circular. Optical fiber components 71 can be disposed within the plurality of formed areas 73. This embodiment includes three optical fiber components, an optical fiber ribbon and two loose fibers, adjacent a plurality of decoupling zones 78 disposed in the plurality of formed areas 73. Additionally, one or more of formed areas 73 can include a coaxial cable, a twisted pair or power wires. The embodiment in FIG. 7 can include an interfacial layer on an outer surface of strength member 72, a decoupling zone 78, and/or a water-blocking component as described herein.

Illustrated in FIG. 8d is fiber optic cable 80 of another embodiment of the present invention. As described in conjunction with the embodiments of FIG. 1, fiber optic cable 80 includes a plurality of formed areas 83 in a strength member 82. FIGS. 8a-8c illustrate the forming process of strength member 82. A blank of FIG. 8a can be shaped according to FIG. 8b or FIG. 8e in a forming process. The strength member 82 of FIG. 8b provides longitudinal formed areas 83 while the strength member of FIG. 8e provides helical formed areas 83′ when formed into a cylinder. The embodiment of either FIG. 8b or 8e can be formed into a predetermined shape, as depicted in FIG. 8c, in the same or a separate forming process. The predetermined shape of FIG. 8c can be circular, triangular, elliptical, rectangular or any other suitable shape. Additionally, formed area 83 can be longitudinally formed as depicted in FIG. 8c and then support member 82 can be twisted to provide a helical lay to formed area 83. Moreover, formed areas 83 are generally in the shape of a U, or optionally a V-shape, and can include various depth, widths and bottom curvatures such as flat or semi-circular. Optical fiber components 81 can be disposed within the plurality of formed areas 83. This embodiment includes three optical fiber components each adjacent a decoupling zone 88 disposed in the plurality of formed areas 83. Also depicted are two ripcords 89a adjacent one optical fiber component 11 and a water-blocking component 89. The embodiment in FIG. 80 can include an interfacial layer on an outer surface of strength member 82, a decoupling zone 88, and/or a water-blocking component as described herein.

Cable 80 could also be adapted for use as a composite cable carrying an electrical signal. FIG. 9 illustrates the addition of a dielectric material 99 surrounding a central electrical conductor 98 in an interior space of a strength member 92 formed from a metallic sheet, preferably, steel having a copper cladding. Consequently, composite cable 90 can function as a ring and tip carrier as well as an optical cable. Moreover, the strength member can substantially shield the signal of the central conductor 99.

Many modifications and other embodiments of the present invention will become apparent to skilled artisans. Therefore, it is to be understood that the present invention is not to be limited to the specific embodiments disclosed and that modifications and other embodiments are intended to be included within the scope of the appended claims. For example, the strength member can have an I-beam shape with the optical component adjacent the vertical member and/or a buffer tube, which houses the optical fiber components with or without a decoupling zone can be disposed within the formed area. Although specific terms are employed herein, they are used in a generic and descriptive sense only and not for purposes of limitation. The invention has been described with reference to drop cable designs but the inventive concepts of the present invention are applicable to other cable types as well.

1. A fiber optic cable, comprising:
a strength member comprising a sheet, said sheet manufactured in a forming process, said sheet having at least one fiber access opening leading to at least one formed area disposed generally longitudinally relative to an axis of the cable;
at least one optical fiber component disposed within said at least one formed area so that the at least one optical fiber component can be accessed at the fiber access opening without substantially disturbing the strength member;
a cable jacket generally surrounding said strength member with at least a portion of the cable jacket being in communication with the at least one fiber access opening; and
an interfacial layer at least partially disposed between an outer surface of said strength member and said cable jacket.

2. A fiber optic cable according to claim 1, said sheet comprising a strip, tape or foil.

3. A fiber optic cable according to claim 1, said strength member having a substantially uniform thickness.

4. A fiber optic cable according to claim 1, said cable having a non-preferential bend characteristic.

5. A fiber optic cable according to claim 1, said cable having a preferential bend characteristic.

6. A fiber optic cable according to claim 1, said at least one formed area being generally V-shaped.

7. A fiber optic cable according to claim 1, said at least one formed area being generally U-shaped.

8. A fiber optic cable according to claim 1, said at least one formed area being generally U-shaped with a generally flat bottom portion.

9. A fiber optic cable according to claim 1, a cross-sectional area of the cable being generally non-circular.

10. A fiber optic cable according to claim 1, said cable jacket including an indicia.

11. A fiber optic cable according to claim 1, said strength member comprising a metallic material.

12. A fiber optic cable according to claim 1, said strength member formed from a metallic sheet, said strength member further comprising an interior space having a central electrical conductor surround by a dielectric material at least partially filling said interior space and functioning as an insulator between said central electrical conductor and said strength member.

13. (canceled)

14. A fiber optic cable according to claim 1, said at least one optical fiber component being adjacent to a decoupling zone.

15. A fiber optic cable according to claim 14, said decoupling zone substantially surrounding the at least one optical fiber component.

16. A fiber optic cable according to claim 1, further comprising a water-blocking component at least partially disposed in said formed area.

17. A fiber optic cable, comprising:
a strength member comprising a sheet, said sheet manufactured in a forming process, said sheet having at least one fiber access opening leading to at least one formed area disposed generally longitudinally relative to the longitudinal axis of the cable;
at least one optical fiber component disposed within said at least one formed area so that the at least one optical fiber component can be accessed at the fiber access opening without substantially disturbing the strength member;
a decoupling zone disposed in said at least one formed area and adjacent to said optical fiber component;
at least one water-blocking component at least partially disposed in said formed area; and
an interfacial layer at least partially disposed between an outer surface of said strength member and a cable jacket generally surrounding said strength member with at least a portion of the cable jacket being in communication with the at least one fiber access opening.

18. A fiber optic cable according to claim 17, said sheet comprising a strip, tape or foil.

19. A fiber optic cable according to claim 17, said strength member having a substantially uniform thickness.

20. A fiber optic cable according to claim 17, said cable having a non-preferential bend characteristic.

21. A fiber optic cable according to claim 17, said cable having a preferential bend characteristic.

22. A fiber optic cable according to claim 17, said decoupling zone substantially surrounding the optical fiber component for substantially decoupling said optical fiber component from said strength member.

23. A fiber optic cable according to claim 17, a cross-sectional area of the cable being non-circular.

24. A fiber optic cable according to claim 17, the cable including an indicia for locating said optical fiber component.

25. A fiber optic cable according to claim 24, said indicia comprising a protrusion above a generally uniform cross-section of said cable.

26. A fiber optic cable according to claim 17, said at least one formed area comprising an interstice, said cable jacket at least partially filling said interstice.

27. A fiber optic cable according to claim 17, said strength member being formed of a metallic sheet, said strength member further comprising an interior space having a central electrical conductor surround by a dielectric material at least partially filling said interior space and functioning as an insulator between said central electrical conductor and said strength member.

28. (canceled)

29. A fiber optic cable according to claim 17, said at least one formed area being generally V-shaped.

30. A fiber optic cable according to claim 17, said at least one formed area being generally U-shaped.

31. A fiber optic cable according to claim 17, said at least one formed area being generally U-shaped with a generally flat bottom portion.

32. A fiber optic cable, comprising:
a strength member comprising a sheet, said sheet manufactured in a forming process having at least one fiber access opening leading to a formed area disposed generally longitudinally relative to an axis of the cable;
at least one optical fiber component disposed within said at least one formed area so that the at least one optical fiber component can be accessed at the fiber access opening without substantially distrubing the strength member;
a cable jacket generally surrounding said strength member with at least a portion of the cable jacket being in communication with the at least one fiber access opening;
an interfacial layer at least partially disposed between an outer surface of said strength member and said cable jacket; and
the cable having a strain of about a 1.0% or less when applying about a 1,000 lb. tensile force.

33. A fiber optic cable according to claim 32, said strength member having a substantially uniform thickness.

34. A fiber optic cable according to claim 32, said cable having a non-preferential bend characteristic.

35. A fiber optic cable according to claim 32, said cable having a preferential bend characteristic.

36. A fiber optic cable according to claim 32, said cable having a strain of about 0.3% or less when applying about a 500 lb. tensile force.

37. A fiber optic cable according to claim 32, said cable having a strain of about 0.3% or less when applying about a 300 lb. tensile force.

38. A fiber optic cable according to claim 32, said at least one optical fiber component being adjacent to a decoupling zone.

39. A fiber optic cable according to claim 38, said decoupling zone substantially surrounding said at least one optical fiber component.

40. A fiber optic cable according to claim 32, further comprising a water-blocking component being partially disposed in said formed area.

41. A fiber optic cable according to claim 32, said cable jacket includes an indicia.

42. A fiber optic cable according to claim 32, said strength member formed from a metallic sheet, said strength member further comprising an interior space having a central electrical conductor surround by a dielectric material at least partially filling said interior space and functioning as an insulator between said central electrical conductor and said strength member.

43. (canceled)

44. (canceled)
